(19) United States
(12) Patent Application Publication
(10) Pub. No.: US 2005/0050558 A1
(43) Pub. Date: Mar. 3, 2005

(54) Disc-stopping device and disc apparatus using the device

(76) Inventors: Kuo-Chun Lee, Taoyuan (TW); Shan-Yen Yang, Taoyuan City (TW); Zhi-Hong Shang, Suzhou (CN)

Correspondence Address: SNELL & WILMER;ONE ARIZONA CENTER, 400 EAST VAN BUREN, PHOENIX, AZ, 850040001, US

(21) Appl. No.: 10/927,368

(22) Filed: Aug. 26, 2004

(30) Foreign Application Priority Data
Aug. 26, 2003 (TW) 92123428

(51) Int. Cl. G11B 17/03

(52) U.S. Cl. 720/601

(57) ABSTRACT

A disc-stopping device for preventing disc scratches is disclosed. The disc-stopping device is used in a disc apparatus. The disc apparatus includes a chassis and a tray. The tray, which holds the disc, is movably connected to the chassis and selectively located at an ejection position and an access position. The disc-stopping device includes a stopper and a supporter. The stopper is disposed on the tray and substantially located on a first plane relative to the tray. The supporter is disposed on the chassis. When the tray is located at the ejection position, the disc is located on a second plane relative to the tray. When the tray is located at the access position, the disc is located on the first plane. When the ejection operation of the disc is performed, the supporter supports the disc while the stopper stops the rotation of the disc and the stopper pushes the disc to the ejection position.

### CROSS-REFERENCE TO RELATED APPLICATION

This application claims priority of Taiwan Patent Application Serial No. 092123428 entitled “Disc-Stopping Device and Disc Apparatus Using The Device”, filed on Aug. 26, 2003.

### FIELD OF INVENTION

The present invention relates to a disc-stopping device for preventing scratches on disc surfaces. More specifically, the disc-stopping device includes a stopper and a supporter to prevent a rotating disc from directly rubbing against the tray and causing scratches on the disc surface in the event of an emergency ejection.

### BACKGROUND OF THE INVENTION

In conventional disc apparatus, the normal ejection operation is activated by pushing the ejection button on the apparatus, or by software control. When the ejection operation begins, the spindle motor will apply a reverse current to command the spindle to stop. After the spindle stops, the clamper will release the disc. Then the disc falls into the tray and is ejected.

Additionally, the disc apparatus also includes an emergency ejection mechanism. The emergency ejection mechanism is mechanically activated to force the ejection operation, i.e. no reverse current is required. An ejection pin or a clip is inserted into the emergency ejection hole to force the tray to eject. The emergency ejection is performed when the normal ejection operations fail, e.g. software error, apparatus malfunction, disc defect or system malfunction after updating firmware. However, the spindle motor sometimes fails to stop due to these system failures. In these circumstances, performing the emergency ejection operation may lead to some problems. For example, serious scratches on the disc surface may happen when a rotating disc touches the tray. Moreover, the disc may splinter and even hurt users.

For the reasons mentioned above, a mechanical disc-stopping device is required to stop the rotation of the disc and prevent scratches during the emergency ejection operations.

### SUMMARY OF THE INVENTION

It is one aspect of the present invention to provide a disc-stopping device for preventing scratches on disc surfaces, and the disc-stopping device is used in a disc apparatus.

It is another aspect of the present invention to provide a disc-stopping device used in a disc apparatus for preventing disc from splintering and further shooting out of the disc apparatus.

The present invention provides a disc-stopping device for preventing disc scratches. The disc-stopping device is used in a disc apparatus. The disc apparatus includes a chassis and a tray. The tray, which holds the disc, is movably connected to the chassis and selectively located at an ejection position and an access position. The disc-stopping device includes a stopper and a supporter. The stopper is disposed on the tray and substantially located on a first plane relative to the tray. The supporter is disposed on the chassis. When the tray is located at the ejection position, the disc is located on a second plane relative to the tray. When the tray is located at the access position, the disc is located on the first plane. When the ejection operation of the disc is performed, the supporter supports the disc while the stopper stops the rotation of the disc and pushes the disc to the ejection position

The stopper includes a stop portion and an elastic portion, and when the stopper pushes the disc, the stop portion touches the disc to slow down and eventually stop the disc. The supporter is rotatably connected to the chassis to allow the disc to pass from the second plane to the first plane. When ejection operation of the disc is activated, the supporter supports the disc while the stopper stops the rotation of the disc and pushes the disc to the ejection position. When the ejection operation of the disc is performed, the disc falls from the supporter to the tray and is then supported by the tray on the second plane.

In another embodiment of the present invention, the disc-stopping device further includes an auxiliary stopper disposed on the chassis and substantially located on the first plane. When the stopper pushes the disc, the auxiliary stopper touches the disc to stop the rotation of the disc.

In still another embodiment, the present invention discloses a disc apparatus for preventing scratches on the disc surface. The disc apparatus includes a housing, a tray, an access module, stoppers, auxiliary stoppers, and supporters. The housing includes a chassis. The tray, which holds the disc, is movably connected to the chassis and selectively located at an ejection position and an access position. The access module is vertically and movably connected to the chassis for accessing the disc. The stoppers are symmetrically disposed on the tray and substantially located on a first plane relative to the tray. The auxiliary stoppers are symmetrically disposed on the chassis and substantially located on the first plane. The supporters are symmetrically and rotatably connected to the chassis, and the supporters rotate to allow the disc to move from a second plane to the first plane.

When the tray is located at the ejection position, the disc is located on the second plane relative to the tray and held by the tray. When the tray is located at the access position, the disc is driven to the first plane and accessed by the access module. When the ejection operation of the disc is performed, the supporters support the disc while the stoppers and the auxiliary stoppers stop the rotation of the disc, and the stoppers push the disc to the ejection position.

### BRIEF DESCRIPTION OF THE DRAWINGS

FIG. 1 shows a disc-stopping device of one embodiment in accordance with the present invention;

FIG. 2A is a cross-sectional view along the line I-I in FIG. 1, wherein the tray is located at the access position and the disc is located on the second plane;

FIG. 2B is a cross-sectional view along the line II-II in FIG. 1, wherein the tray is located at the access position and the disc is located on the second plane;

FIG. 3A is a cross-sectional view along the line I-I in FIG. 1, wherein the tray is located at the access position and the disc is located on the first plane;

FIG. 3B is a cross-sectional view along the line II-II in FIG. 1, wherein the tray is located at the access position and the disc is located on the first plane;

FIG. 3C shows the rotation of the supporter;

FIG. 4A is a cross-sectional view along the line I-I in FIG. 1, wherein the tray is located at the ejection position;

FIG. 4B is a cross-sectional view along the line II-II in FIG. 1, wherein the tray is located at the ejection position;

FIG. 5 is a three-dimensional view of a disc-stopping device in accordance with the present invention, wherein the tray is located at the access position;

FIG. 6 is a three-dimensional view of a disc-stopping device in accordance with the present invention, wherein the tray is located at the ejection position; and

FIG. 7 is a three-dimensional view of a disc apparatus in accordance with the present invention.

### DETAILED DESCRIPTION

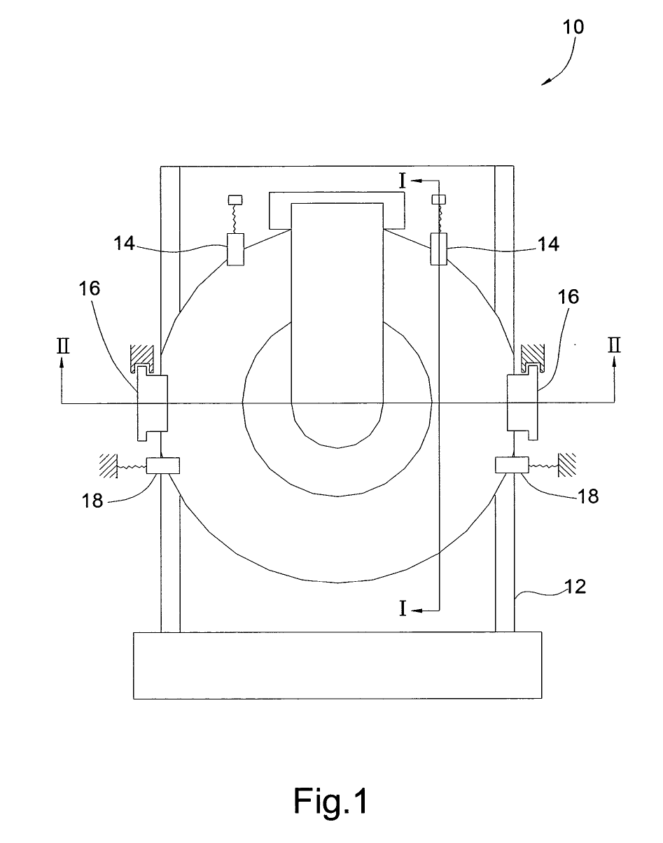

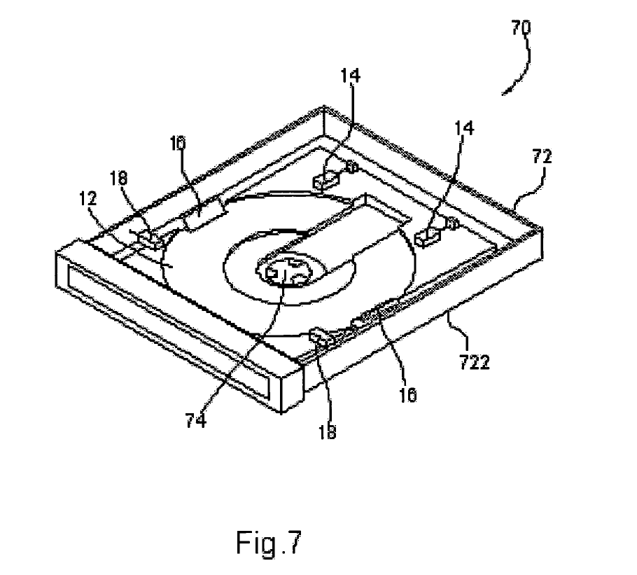

The present invention providing a disc-stopping device for preventing disc scratches is disclosed. FIG. 1 illustrates a disc-stopping device 10 in accordance with the present invention. The disc-stopping device 10 is used in a disc apparatus 70 (shown in FIG. 7). The disc apparatus 70 includes a housing 72, an access module 74, and a tray 12. The housing 72 has a chassis 722. The tray 12, which holds the disc (not shown in FIG. 1), is slidably connected to the chassis 722 and selectively located at an ejection position and an access position relative to the chassis 722. Those skilled in the art should know that the housing 72 and the access module 74 are not shown in FIG. 1 for clarity. The disc-stopping device 10 includes stoppers 14, supporters 16 and auxiliary supporters 18. Two stoppers 14 are illustrated here only for an exemplary embodiment, and the actual number of the stoppers 14 can depend on the shape and design of the disc apparatus 70. The stoppers 14 are disposed on the tray 12 and substantially located on a first plane 22 (shown in later figures) relative to the tray 12. The description “substantially on a first plane 22” as used here refers to how the stoppers 14 interact with the disc on the first plane 22, regardless of the shape and thickness of the stoppers 14. Similarly, two supporters 16 are illustrated only for explaining the invention. The supporters 16 are rotatably disposed on the chassis 722 and the tray 12 is located between these two supporters 16. Again, two auxiliary stoppers 18 are illustrated only for explaining the invention, and can be changed according to the shape and design of the disc apparatus 70. Two auxiliary stoppers 18 are symmetrically disposed on the chassis 722 and substantially located on the first plane 22.

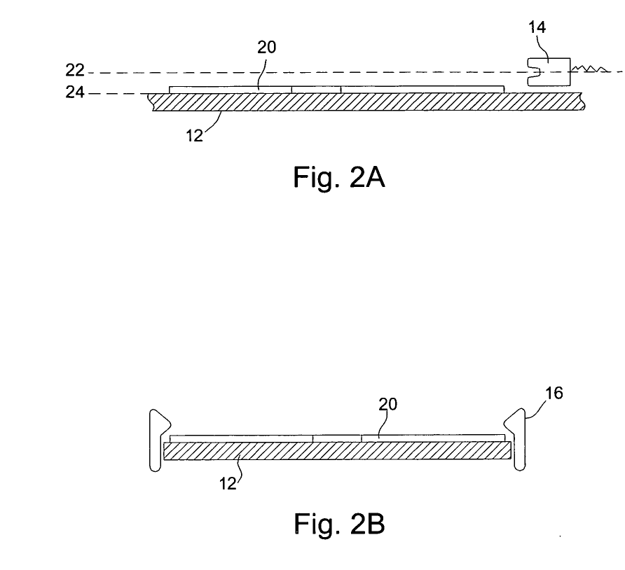

FIG. 2A and FIG. 2B are schematic views illustrating that the tray 12 holds the disc 20 and moves from the ejection position to the access position. It should be noted that the disc 20 is located on a second plane 24 relative to the tray 12 in this operation. FIG. 2A is a cross-sectional view along the line I-I in FIG. 1 and illustrates the relative position between the disc 20 and the stoppers 14. FIG. 2B is a cross-sectional view along the line II-II in FIG. 1 and illustrating the relative position between the disc 20 and the supporters 16. The disc 20 is close to but not in contact with the stoppers 14 and supporters 16 at this time. After the tray 12 moves to the access position, the access module 74 (not shown) moves the disc 20 from the second plane 24 to the first plane 22, and prepares to access (i.e. read and/or write) the information of the disc 20.

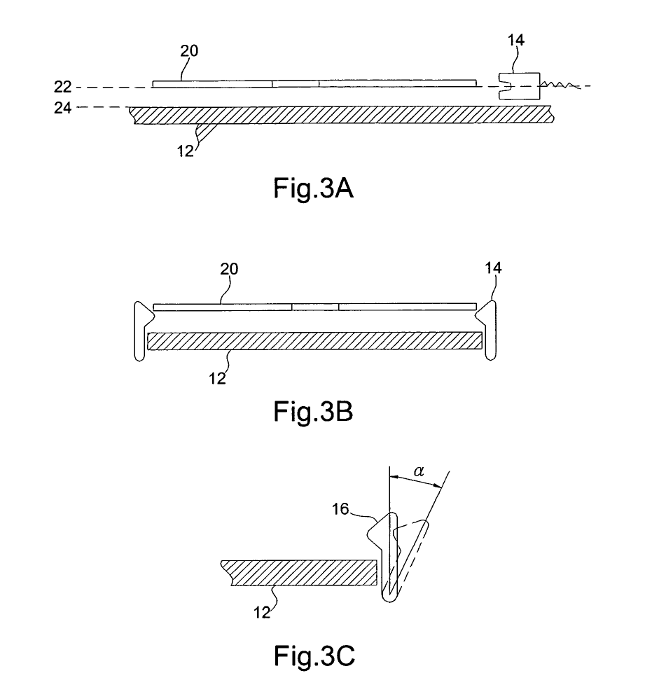

FIG. 3A and FIG. 3B are schematic views illustrating that the access module 74 moves the disc 20 to the first plane 22. FIG. 3A is a cross-sectional view along the line I-I in FIG. 1 and illustrates the relative position between the disc 20 and the stoppers 14. FIG. 2B is a cross-sectional view along the line II-II in FIG. 1, illustrating the relative position between the disc 20 and the supporters 16. The disc 20 is located on the first plane 22, and rotated by the access module 74 for accessing the information within the disc 20. The disc 20 is close to but not in contact with the stoppers 14 and supporters 16 at this time. It should be noted that when the disc 20 moves from the second plane 24 to the first plane 22, the supporters 16 may rotate an angle α to allow the disc 20 to pass through (shown in FIG. 3C).

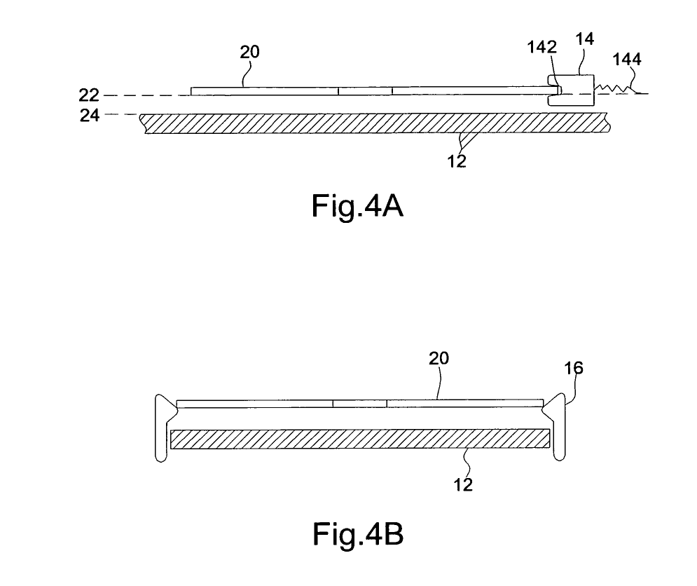

When the disc apparatus 70 receives an ejection signal to eject the disc 20, or a user performs the emergency ejection operation (referred to as “ejection operation” hereinafter), the tray 12 begins to move from the access position to the ejection position. FIG. 4A and FIG. 4B are schematic views illustrating that the tray 12 moves from the access position to the ejection position. FIG. 4A is a cross-sectional view along the line I-I in FIG. 1, illustrating the relative position between the disc 20 and the stoppers 14. FIG. 4B is a cross-sectional view along the line II-II in FIG. 1, illustrating the relative position between the disc 20 and the supporters 16. Each of the stoppers 14 includes a stop portion 142 and an elastic portion 144. When the tray 12 moves from the access position to the ejection position, the stoppers 14 move with the tray 12. Therefore, the stop portion 142 of the stopper 14 touches, slows down, and eventually stops the disc 20. The elastic portion 144 of the stopper 14 acts as a cushion mechanism for absorbing the impact while touching the disc 20. Meanwhile, the access module 74 descends and releases the disc 20, and the supporters 16 continue to hold the disc 20.

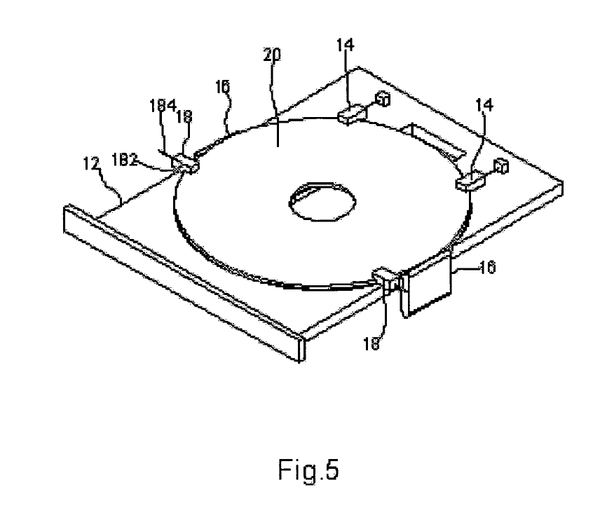

FIG. 5 is a three-dimensional view of disc-stopping device 10. When the disc 20 is supported by the supporters 16, the stoppers 14 moves the disc 20 to further touch the auxiliary stoppers 18. Similarly, each of the auxiliary stoppers 18 includes a stop portion 182 and an elastic portion 184. The auxiliary stoppers 18 work together with the stoppers 14 to effectively stop the disc 20. Also, the elastic portion 184 of the auxiliary stopper 18 acts as a cushion mechanism to absorb the impact while touching the disc 20. Due to the mechanical design of the stoppers 14 and the auxiliary stoppers 18, the disc 20 can be effectively stopped even if disc apparatus fails to apply a reverse current to command the spindle when, for example, a user performs the emergency operation. Thus, the disc 20 will stop rotating before it falls on the tray, and the scratches over a surface of disc can be prevented. Moreover, the present invention can prevent the disc from splintering and even hurting users.

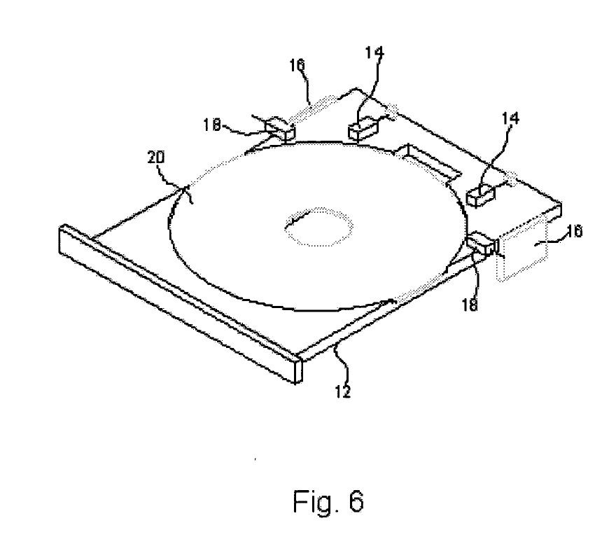

The stoppers 14 moves the disc 12 until the tray 12 moves to the ejection position. The disc 20 keeps moving with the stoppers 14 until the disc 20 passes the supporters 16. Then the disc 20 falls back to the second plane 24 and is supported by the tray 12 (shown in FIG. 6). At this time, the disc 20 is available to the user, (e.g. to retrieve the disc or exchange a new disc).

FIG. 7 is a three-dimensional view of disc apparatus 70 in accordance with the present invention. The housing 72 accommodates the disc-stopping device 10, the tray 12, and the access module 74.

It should be noted that the supporters 16, the stop portion 142 of the stopper 14, and the stop portion 182 of the auxiliary stopper 18 all include smooth surfaces (e.g. sloping or curved surfaces, or the like). Thus, they only touch the edge portion of the disc 20 and do not scratch the surface of the disc 20.

The spirit and scope of the present invention can be clearly understood by the above detailed descriptions of the preferred embodiments. The embodiments are not intended to limit the scope of the invention. Contrarily, various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

1. A disc-stopping device for use in a disc apparatus for preventing scratches over a surface of disc, the disc apparatus includes a chassis and a tray holding the disc, the tray slidably connected to the chassis and selectively located at an ejection position and an access position, the disc-stopping device comprising:
a stopper disposed on the tray and substantially located at a first plane relative to the tray; and
a supporter disposed on the chassis;
wherein when the tray is located at the ejection position, the disc is located at a second plane relative to the tray, when the tray is located at the access position, the disc is located at the first plane, and when ejection operation of the disc is performed, the supporter supports the disc while the stopper stops the rotation of the disc and pushes the disc moving to the ejection position.

2. The disc-stopping device of claim 1, wherein the stopper comprises a stop portion and an elastic portion, and when the stopper pushes the disc, the stop portion touches the disc.

3. The disc-stopping device of claim 1, further comprising an auxiliary stopper disposed on the chassis and substantially located at the first plane, wherein when the stopper pushes the disc, the auxiliary stopper touches the disc to stop the rotation of the disc.

4. The disc-stopping device of claim 3, wherein the auxiliary stopper comprises a stop portion and an elastic portion, and when the auxiliary stopper pushes the disc, the stop portion touches the disc.

5. The disc-stopping device of claim 1, wherein the supporter is rotatably connected to the chassis to allow the disc passing from the second plane to the first plane.

6. The disc-stopping device of claim 1, wherein when ejection operation of the disc is performed, the disc falls from the supporter to the tray and becomes supported by the tray at the second plane.

7. A disc-stopping device for use in a disc apparatus for preventing scratches over a surface of disc, the disc apparatus includes a chassis and a tray holding the disc, the tray slidably connected to the chassis and selectively located at an ejection position and an access position, the disc-stopping device comprising:
a plurality of stoppers symmetrically disposed on the tray and substantially located at a first plane relative to the tray;
a plurality of auxiliary stoppers symmetrically disposed on the chassis and substantially located at the first plane; and
a plurality of supporters symmetrically and rotatably connected to the chassis to allow the disc moving from a second plane to the first plane;
wherein when the tray is located at the ejection position, the disc is located at the second plane relative to the tray, when the tray is located at the access position, the disc is located at the first plane, and when the ejection operation of the disc is performed, the supporters support the disc while the stoppers and the auxiliary stoppers stop the rotation of the disc, and the stoppers push the disc moving to the ejection position.

8. The disc-stopping device of claim 7, wherein each of the stoppers comprises a stop portion and an elastic portion, and when the stoppers push the disc, the stop portion of the stoppers touch the disc.

9. The disc-stopping device of claim 7, wherein each of the auxiliary stoppers comprises a stop portion and an elastic portion, and when the stoppers push the disc, the stop portion of auxiliary stoppers touch the disc.

10. The disc-stopping device of claim 7, wherein when the ejection operation of the disc is performed, the disc falls from the supporters to the tray and becomes supported by the tray at the second plane.

11. A disc apparatus for preventing scratches over a surface of disc, comprising:
a housing includes a chassis;
a tray holding the disc, the tray slidably connected to the chassis and selectively located at an ejection position and an access position;
an access module vertically and movably connected to the chassis for accessing the disc;
at least one stopper disposed on the tray and substantially located at a first plane relative to the tray;
a plurality of auxiliary stoppers symmetrically disposed on the chassis and substantially located at the first plane; and
a plurality of supporters symmetrically and rotatably connected to the chassis, and the supporters rotate to allow the disc moving from a second plane to the first plane;
wherein when the tray is located at the ejection position, the disc is located at the second plane relative to the tray, when the tray is located at the access position, the disc is located at the first plane, and when the ejection operation of the disc is performed, the supporters support the disc while the stoppers and the auxiliary stoppers stop the rotation of the disc, and the stoppers push the disc moving to the ejection position.

12. The disc apparatus of claim 11, wherein each of the stoppers and the auxiliary stoppers comprises a stop portion and an elastic portion, and when the stoppers push the disc, the stop portion of the stoppers and the stop portion of the auxiliary stoppers touch the disc.

13. The disc apparatus of claim 11, wherein when the ejection operation of the disc is performed, the disc falls from the supporters to the tray and becomes supported by the tray at the second plane.
